(19) United States
(12) Patent Application Publication
(10) Pub. No.: US 2015/0015698 A1
(43) Pub. Date: Jan. 15, 2015

(54) METHODS AND SYSTEMS FOR OPTICAL AIRCRAFT DETECTION

(71) Applicant: Gulfstream Aerospace Corporation, Savannah, GA (US)

(72) Inventor: Michael Knight, Savannah, GA (US)

(21) Appl. No.: 13/938,419

(22) Filed: Jul. 10, 2013

(51) Int. Cl. G08G 5/04; G08G 5/00

(52) U.S. Cl. CPC G08G 5/045; G08G 5/0078; G08G 5/0047; G08G 5/0021
USPC 348/115; 348/117

(57) ABSTRACT

The disclosed embodiments relate to methods and systems for identifying air traffic. A method is provided in which images from a camera positioned on the aircraft are processed via a processor. The processor uses data from the images to identify air traffic within a field of view of the camera and displays an indication of the position of the air traffic relative to the aircraft on a display to provide air traffic information. A system is also provided that includes an aircraft that includes a camera configured to provide image data within a field of view of the camera to a processor for processing the image data to identify air traffic within the field of view of the camera. The processor displays an icon representing the position of the air traffic within the field of view of the camera on a display to provide air traffic information.

### TECHNICAL FIELD

Embodiments of the present invention generally relate to aircraft, and more particularly relate to methods and systems for optically detecting air traffic during flight and advising the pilot(s) of the air traffic.

### BACKGROUND OF THE INVENTION

Visual detection of aircraft, even in good visibility and with cueing from air traffic control or other systems, is difficult for the unaided human eye. The air traffic controller may advise the pilot of an aircraft to the presence of other aircraft (air traffic) that have the potential for conflict in flight paths in and around the congested terminal airspace near airports. Even if the air traffic controller provides a direction for the pilot(s) to look (e.g., “traffic is at your 1 o'clock at 1000 feet”), it is not uncommon for some pilots not to see the air traffic until several seconds later, if at all.

The pilot remains the last line of defense to see and avoid other aircraft which may not be cooperative (not under air traffic control) or which may have inadvertently deviated from air traffic control instructions, approach or take-off paths and created a conflict in flight paths between the aircraft and the air traffic.

Accordingly, it is desirable to detect air traffic in the vicinity of an aircraft. It is further desirable that the pilot(s) be advised of the air traffic and assisted in tracking the air traffic. Other desirable features and characteristics of the present invention will become apparent from the subsequent detailed description and the appended claims, taken in conjunction with the accompanying drawings and the foregoing technical field and background.

### SUMMARY

In one embodiment, a method is provided in which images from a camera positioned on the aircraft are processed via a processor. The processor uses data from the images to identify air traffic within a field of view of the camera and displays an indication of the position of the air traffic relative to the aircraft on a display to provide air traffic information.

In another embodiment, a system is provided. The system includes an aircraft that includes a camera configured to provide image data within a field of view of the camera to a processor for processing the image data to identify air traffic within the field of view of the camera. The processor displays an icon representing the position of the air traffic within the field of view of the camera on a display to provide air traffic information.

### DESCRIPTION OF THE DRAWINGS

Embodiments of the present invention will hereinafter be described in conjunction with the following drawing figures, wherein like numerals denote like elements, and

FIGS. 1A and 1B are illustrations of an aircraft in accordance with an embodiment;

FIG. 2 is a block diagram of flight control systems in accordance with an embodiment;

FIGS. 3-5 are illustrations of displays of an aircraft in accordance with an embodiment; and

FIG. 6 is a flowchart of a method in accordance with an embodiment.

### DESCRIPTION OF EXEMPLARY EMBODIMENTS

As used herein, the word “exemplary” means “serving as an example, instance, or illustration.” The following detailed description is merely exemplary in nature and is not intended to limit the invention or the application and uses of the invention. Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims. Furthermore, there is no intention to be bound by any expressed or implied theory presented in the preceding technical field, background, summary or the following detailed description.

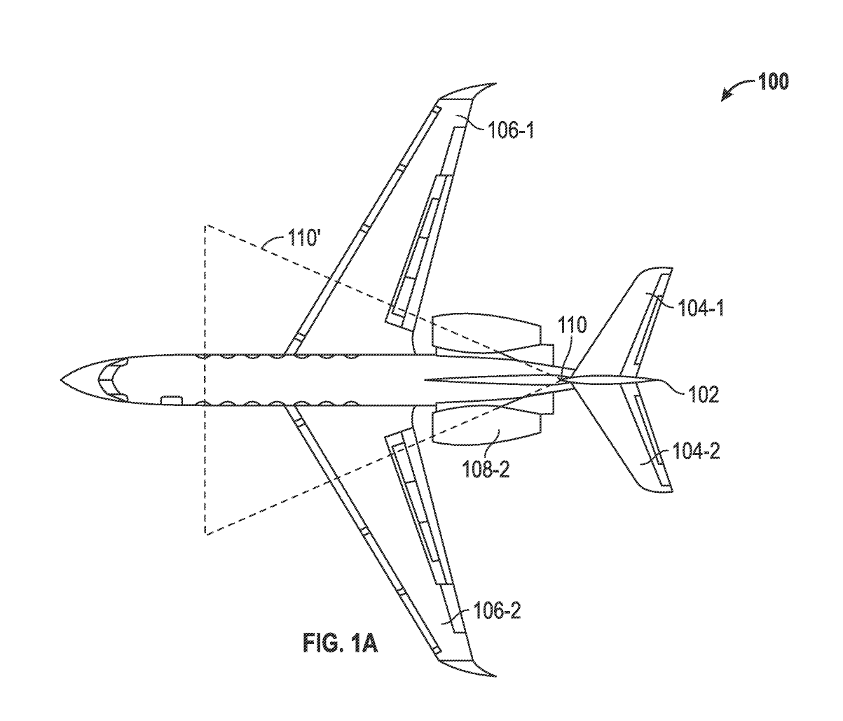

Referring to FIGS. 1A and 1B, FIG. 1A is a top view of an aircraft 100 that includes instrumentation for implementing an optical air traffic detection system in accordance with some embodiments. As will be described below, the optical air traffic detection system can be used to reduce or eliminate the likelihood of a collision of an aircraft 100 with air traffic that are in proximity of the aircraft when the aircraft is in flight.

In accordance with one non-limiting embodiment, the aircraft 100 includes a vertical stabilizer 102, two horizontal stabilizers 104-1 and 104-2, two main wings 106-1 and 106-2, two jet engines 108-1, 108-2, and an optical air traffic detection system that includes cameras 110-114 that are disposed at various locations on the aircraft 100 as illustrated in FIGS. 1A and 1B. Although the jet engines 108-1, 108-2 are illustrated as being mounted to the fuselage, this arrangement is non-limiting and in other implementations the jet engines 108-1, 108-2 can be mounted on the wings 106-1, 106-2. The number and respective locations of the illustrated cameras 110-114 are non-limiting. In other implementations, either fewer or more cameras can be implemented, at either the same or different locations on the aircraft 100.

The cameras 110-114 are used to acquire video images of a field of view (FOV) 110′-114′, and to generate images of objects within the FOV. In some embodiments, the cameras 110- 114 are video cameras capable of acquiring video images with the FOV at a selected frame rate (e.g., thirty frames per second). In some embodiments, the cameras 110-114 are still image cameras that can be operated at a selected or variable image capture rate according to a desired image input rate. Additionally, some or all of the cameras 110-114 may be implemented using cameras such as high-definition cameras, video with low-light capability for night operations and/or cameras with infrared (IR) capability, etc. In accordance with exemplary operating scenarios, one or more of the cameras 110-114 capture images of air traffic within each respective FOV. That is, in some embodiments, a particular camera (for example, camera 110) may be selected for capturing images used to identify air traffic. In some embodiments, multiple cameras may be employed and the respective FOVs combined or “stitched” together using convention virtual image techniques.

The FOVs 110′-114′ of the cameras 110-114 may vary depending on the implementation and design of the aircraft 100 so that the optical detection zone can be varied either by the operator or automatically depending on other information. In some embodiments, the FOVs 110′-114′ of the cameras can be fixed, while in others it can be adjustable. For example, in one implementation, the camera 110 may have a variable focal length (i.e., a zoom lens) which can be modified to vary the FOV 110′ and/or direction of view. Thus, this embodiment can vary the range and field of view based on the surrounding area and/or the speed and direction of travel of the aircraft so that the location and size of the space within the FOV 110′ can be varied. When the video imagers 120-1 . . . 120-12 have an adjustable FOV (e.g., a variable FOV), a processor (not illustrated in FIG. 1) can command the camera lens to a preset FOV. The range of the cameras 110-114 can also vary depending on the implementation and design of the aircraft 100.

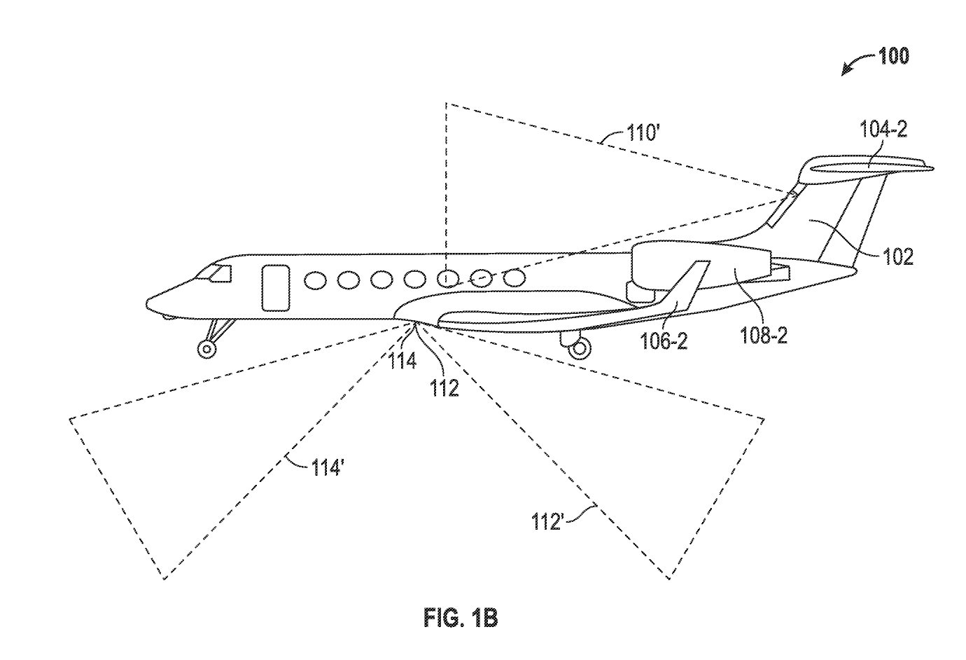

FIG. 2 is block diagram of various flight control systems 200 for an aircraft 100 that implements an optical air traffic detection system and/or is capable of an optical air traffic detection method in accordance with exemplary embodiments. The various flight control systems 200 includes a computer 202, an Advanced Flight Control System (AFCS) 204, a Flight Management System (FMS) 206, an Enhanced Ground Proximity Warning System (EGPWS) 208, an Instrument Landing System (ILS) 210, an Automatic Dependent Surveillance-Broadcast (ADS-B) system 211 and a display unit 212.

The computer 202 and the AFCS 204 collaborate in order to provide instructions to the pilot in order to direct the aircraft along a landing approach plan. The FMS 206 is configured to provide to the computer 202 data regarding the flight, while the EGPWS 208 provides the computer 202 with a geometric altitude, where the geometric altitude represents a three-dimensional model of terrain. This three-dimensional model of terrain may be sent to the display unit 212 for presentation to the pilot(s) via a synthetic vision display. The AFCS 204, the FMS 206, and the EGPWS 208 are disposable within the computer 202 or within other avionics shown in FIG. 2 or at other locations in an aircraft.

Accordingly to exemplary embodiments, the cameras 110-114 and camera control 214 provide raw or processed camera images to the computer 202. In some embodiments, raw images can be sent to the computer 202 for processing in a software embodiment. In some embodiments, hardware, firmware and/or software process the raw image data via the camera control 214 and provide processed image data to the computer 202. In other embodiments, the camera control 214 can be configured to send processed image data directly to the display 212.

Generally, the cameras 110-114 receive digital image representations via charge-coupled devices (CCDs) within the cameras or other digital imaging technology. The digital image representations comprise digital data point known as pixels that can be individually analyzed or analyzed in groups as is known in the art. By employing digital imaging techniques such as blob analysis, groups of pixels representing air traffic can be identified and the relative position of the air traffic to the aircraft displayed on the display 212. As used herein, blob analysis (or blob detection) refers to a conventional process by which regions or groups of pixels are identified such as by differences in brightness, color or other factors in comparison to the surrounding pixels within a FOV. Additionally, since air traffic moves at much greater speeds than other shapes (e.g., clouds or birds), analyzing the frame-to-frame movement of a blob can aid in identifying air traffic from other shapes in the FOV or shapes which are moving relative to the detecting aircraft's flight path.

In some embodiments, only a portion of the FOV is processed to identify air traffic. In a non-limiting example, if the air traffic is broadcasting ADS-B data, the position and altitude data included in the ADS-B transmission may be used by the computer 202 to process only a portion of the entire FOV to identify the air traffic. This embodiment offers an computing advantage if computing resources are limited or unable to process the entire FOV in real time.

Typically, the majority of an aircraft's flight path is above the cloud layer, so detecting air traffic from other shapes is more readily accomplished. However, during take-off and landing maneuvers, there is likely to be a greater concentration of air traffic, and the aircraft and/or the air traffic may pass through a cloud layer or be flying between clouds. Once air traffic has been identified, the air traffic can be presented to the pilot(s) via one or more display screens in the display unit 212.

The display unit 212 displays information regarding the status of the aircraft. The display unit 290 receives information from various systems to provide additional information to the pilot. For example, the AFCS 204 is operable to provide to the display unit 112 information for a flight display 218, such as, for example, attitude of the aircraft, speed and other flight characteristics. The display unit 212 typically also includes, but is not limited to an annunciator 220 to provide verbal warnings, alert or warning tones or other audible information. The display screen 222 of the display unit 212 may include synthetic vision displays, pilot heads-up display, traffic collision avoidance display or other displays as my be included in any particular embodiment. Some displays 222 include icons 224 that are illuminated to indicate the occurrence of certain conditions and/or a text message screen 226 to display text information.

In accordance with one embodiment, the various flight control systems 200 illustrated in FIG. 2 is implemented with software and/or hardware modules in a variety of configurations. For example, computer 202 comprises a one or more processors, software module or hardware modules. The processor(s) reside in single integrated circuits, such as a single or multi-core microprocessor, or any number of integrated circuit devices and/or circuit boards working in cooperation to accomplish the functions of the computer 202. The computer 202 is operable coupled to a memory system 228, which may contain the software instructions or data for the computer 202, or may be used by the computer 202 to store information for transmission, further processing or later retrieval. In accordance with one embodiment, the memory system 228 is a single type of memory component, or composed of many different types of memory components. The memory system 228 can include non-volatile memory (e.g., Read Only Memory (ROM), flash memory, etc.), volatile memory (e.g., Dynamic Random Access Memory (DRAM)), or some combination of the two. In an embodiment, the optical air traffic detection system is implemented in the computer 202 via a software program stored in the memory system 228.

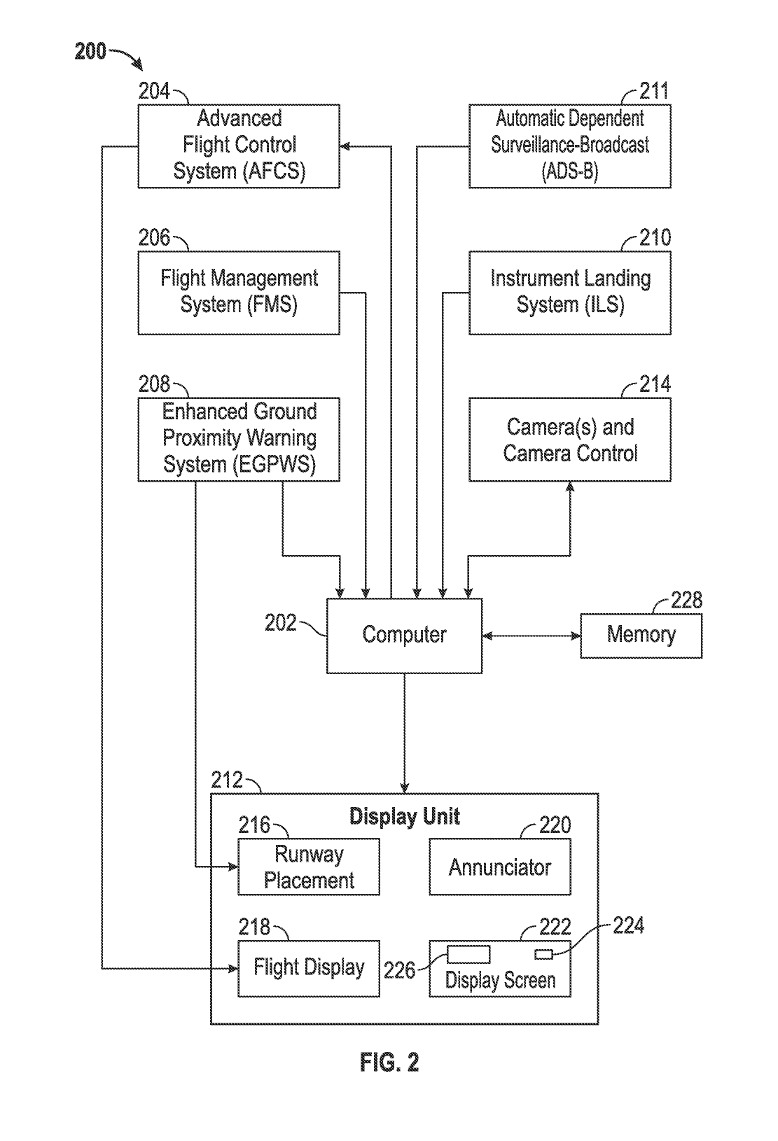

Once air traffic has been identified, it can be presented to the pilot(s) on a variety of displays. FIGS. 3-5 are illustrations of some exemplary displays that could be employed in any particular implementation. In FIG. 3, a synthetic terrain display 300 presents the air traffic as icons 302 and 304. In some embodiments, the icon may be as simple as a square 302. Alternately, circles, ovals, rectangles, polygons, or other primitive icon shapes could be used to represent an aircraft or potential air traffic. In some embodiments, a triangular icon 304 is used as it can also convey the direction of the air traffic via the position of the apex of the triangle. Additionally, the icons could include a color feature, such as, for example, a green color if the air traffic is moving generally away from the aircraft, and amber color if the air traffic is moving generally toward the aircraft and a red color if the air traffic is either within a predetermined range (e.g., three nautical miles) or has an interesting course with the aircraft.

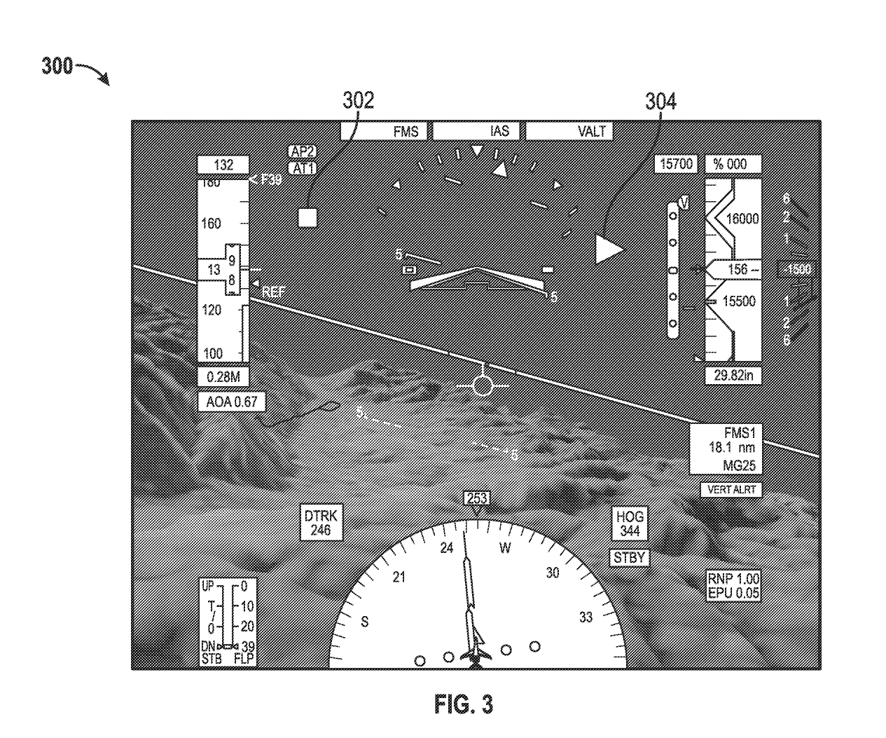

In FIG. 4, a pilot heads-up display 400 is illustrated and presents air traffic icon 402 as a circular shape within the heads-up display. In this example, the icon 402 includes a directional indicator (the arrow) to inform the pilot(s) of the general direction of the air traffic. Again, a color feature could be used to indicate movement toward or away from the air craft.

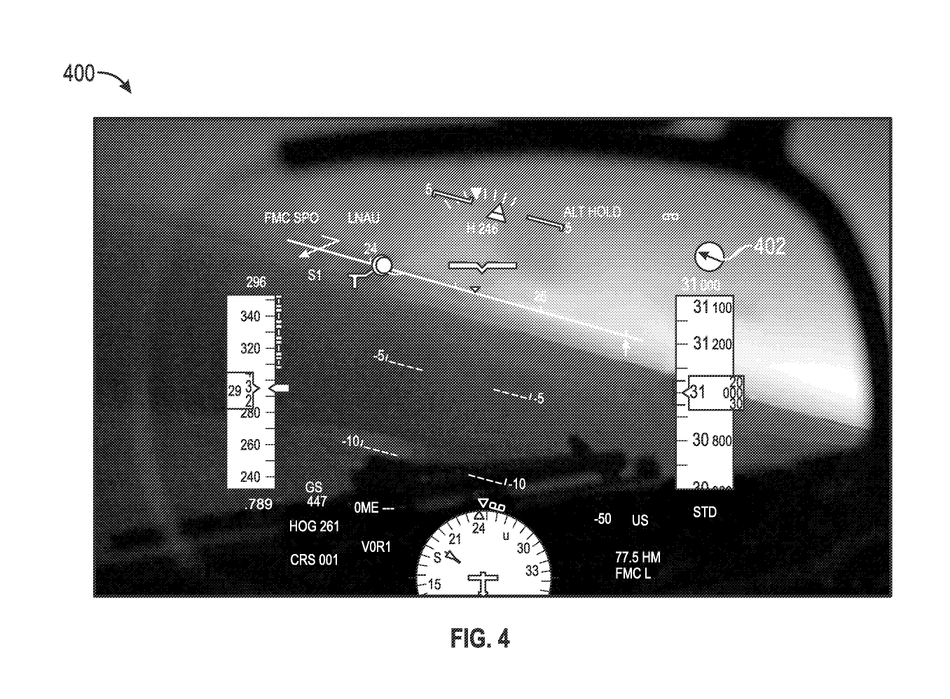

In FIG. 5, a traffic collision avoidance system (TCAS) display 500 is illustrated as showing air traffic icons 502 and 504. Use of the TCAS display 500 may be advantageous for air traffic that is outside the FOV of the synthesized vision display 300 or the heads-up display 400. In this embodiment, diamond shaped icons indicate whether the air traffic is headed generally away from the aircraft via an open center (icon 502) or a closed or is headed generally toward the aircraft via a closed center (icon 504). Additionally, information such as altitude relative to the aircraft can be provided as well as whether the air traffic is ascending or descending (the down arrow in icon 504).

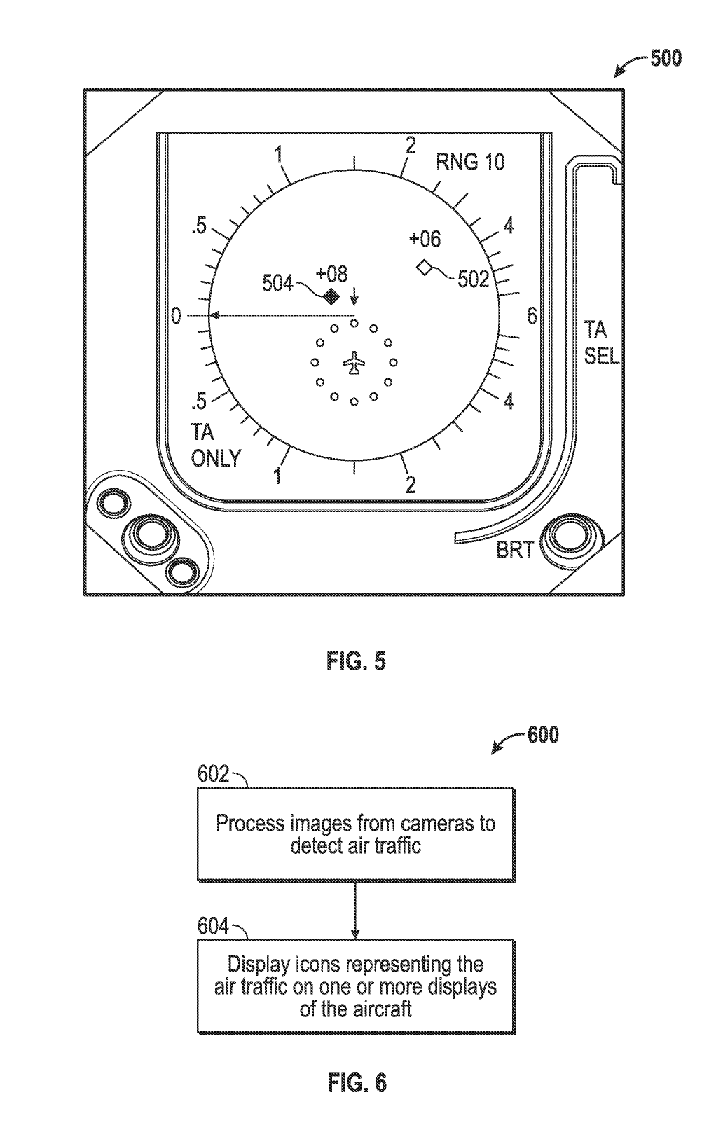

FIG. 6 is a flowchart of a method 600 illustrating the steps performed by the The various tasks performed in connection with the method 600 of FIG. 6 may be performed by software executed in a processing unit, hardware, firmware, or any combination thereof. For illustrative purposes, the following description of the method 600 of FIG. 6 may refer to elements mentioned above in connection with FIGS. 1-5. In practice, portions of the method of FIG. 6 may be performed by different elements of the described system. It should also be appreciated that the method of FIG. 6 may include any number of additional or alternative tasks and that the method of FIG. 6 may be incorporated into a more comprehensive procedure or process having additional functionality not described in detail herein. Moreover, one or more of the tasks shown in FIG. 6 could be omitted from an embodiment of the method 600 of FIG. 6 as long as the intended overall functionality remains intact.

The routine begins in step 602, where camera image data is processed via the camera control (214 in FIG. 2) or the computer (202 in FIG. 2). In some embodiments, the entire FOV is processed to identify air traffic. In some embodiments, such as when the air traffic is broadcasting ADS-B data, only a portion of the entire FOV to is processed to identify air traffic. In this embodiment, the computer 202 can utilize the position and altitude data included in the ADS-B transmission to select a portion of the entire FOV for processing. This embodiment offers an computing advantage if computing resources are limited or unable to process the entire FOV in real time.

Next, icons representing the air traffic is presented on one or more displays of the aircraft (100 in FIG. 1A). The display may be a synthetic vision display (300 in FIG. 3), a heads-up display (400 in FIG. 4), a TCAS display (600 in FIG. 6) or any other display in the aircraft. Optionally, additional information may be presented via color features, indicators or numeric information.

The disclosed methods and systems provide an optical air traffic detection system for an aircraft that enhances safe air travel by augmenting pilot vision with a visual indicator of air traffic location and direction relative to the aircraft being flown by the pilot.

It will be appreciated that the various illustrative logical blocks/tasks/steps, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The word “exemplary” is used exclusively herein to mean “serving as an example, instance, or illustration.” Any embodiment described herein as “exemplary” is not necessarily to be construed as preferred or advantageous over other embodiments.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. An air traffic detection method for an aircraft, comprising:
processing images from a camera positioned on the aircraft via a processor, the processor using data from the images to identify air traffic within a field of view of the camera; and
displaying an indication of the position of the air traffic relative to the aircraft on a display to provide air traffic information.

2. The air traffic detection method for an aircraft according to claim 1, wherein displaying comprises displaying the indication on a synthetic vision display.

3. The air traffic detection method for an aircraft according to claim 1, wherein displaying comprises displaying the indication on a heads-up display.

4. The air traffic detection method for an aircraft according to claim 1, wherein displaying comprises displaying the indication on a traffic collision avoidance system display.

5. The air traffic detection method for an aircraft according to claim 1, further comprising:
determining whether the air traffic is headed generally toward or away from the aircraft; and
displaying information of whether the air traffic is headed generally toward or away from the aircraft.

6. The air traffic detection method for an aircraft according to claim 5, further comprising displaying the indication in a first color when the air traffic is headed generally away from the aircraft and displaying the indication in a second color when the air traffic is headed generally toward the aircraft.

7. The air traffic detection method for an aircraft according to claim 1, further comprising displaying directional information for the air traffic.

8. The air traffic detection method for an aircraft according to claim 1, further comprising displaying relative altitude information for the air traffic.

9. An air traffic detection method for an aircraft, comprising:
processing a plurality of images from a camera positioned on the aircraft via a processor, the processor using data from the plurality of images to identify air traffic within a field of view of the camera and determining speed and direction of the air traffic by comparing movement of the air traffic within the field of view between the plurality of images; and
displaying an indication of the position, speed and direction of the air traffic relative to the aircraft on a display to provide air traffic information.

10. The air traffic detection method for an aircraft according to claim 9, wherein displaying comprises displaying the indication on a synthetic vision display.

11. The air traffic detection method for an aircraft according to claim 9, wherein displaying comprises displaying the indication on a heads-up display.

12. The air traffic detection method for an aircraft according to claim 9, wherein displaying comprises displaying the indication on a traffic collision avoidance system display.

13. The air traffic detection method for an aircraft according to claim 9, further comprising:
determining whether the air traffic is headed generally toward or away from the aircraft; and
displaying information of whether the air traffic is headed generally toward or away from the aircraft.

14. The air traffic detection method for an aircraft according to claim 13, further comprising displaying the indication in a first color when the air traffic is headed generally away from the aircraft and displaying the indication in a second color when the air traffic is headed generally toward the aircraft.

15. The air traffic detection method for an aircraft according to claim 9, further comprising displaying relative altitude information for the air traffic.

16. An aircraft, comprising:
a camera for providing image data within a field of view of the camera;
processor for processing the image data to identify air traffic within the field of view of the camera and providing an icon representing the position of the air traffic within the field of view of the camera;
a display for displaying the icon to provide air traffic information.

17. The aircraft according to claim 16, wherein the processor determines speed and direction of the air traffic and display the speed and direction of the air traffic on the display.

18. The aircraft according to claim 16, wherein the processor:
determines whether the air traffic is headed generally toward or away from the aircraft; and
displays information of whether the air traffic is headed generally toward or away from the aircraft.

19. The aircraft according to claim 16, wherein the processor displays relative altitude information for the air traffic on the display.

20. The aircraft according to claim 16, wherein the display comprises at least one of the following group of displays: synthetic vision, heads-up and traffic collision avoidance system.
